(19) United States
(12) Patent Application Publication
(10) Pub. No.: US 2005/0188543 A1
(43) Pub. Date: Sep. 1, 2005

(54) Pivotal device for scissors

(76) Inventor: Wen-Ya Yeh, Tainan (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/119,643

(22) Filed: May 2, 2005

Related U.S. Application Data
(63) Continuation-in-part of application No. 10/784,621, filed on Feb. 23, 2004, now Pat. No. 6,904,685.

(51) Int. Cl. B26B 13/00

(52) U.S. Cl. 30/254; 30/266

(57) ABSTRACT

A pair of scissors includes two scissor elements and a pivotal device. Each scissor element includes a countersink extending from a first side thereof through a second side thereof. The pivotal device includes a screw and a nut. The screw includes a threaded shank and an enlarged head. The nut includes a non-circular shank and an enlarged head, with a screw hole extending through the non-circular shank and the enlarged head of the nut. The nut is received in the countersink of one of the scissor elements, with the non-circular shank of the nut extending into a non-circular countersink of the other scissor element. The threaded shank of the screw is threadedly engaged with the screw hole of the nut. Thus, the contact area between the screw and the pivotable scissor elements is small.

### CROSS REFERENCE TO RELATED APPLICATION

This is a continuation-in-part application of U.S. patent application Ser. No. 10/784,621 filed Feb. 23, 2004.

### BACKGROUND OF THE INVENTION

1. Field of the Invention

The present invention relates to a pivotal device for a pair of scissors.

2. Description of the Related Art

FIGS. 9 and 10 of the drawings illustrate a pair of conventional scissors including a scissor element 1 and a second scissor element 2. The first scissor element 1 and the second scissor element 2 are pivotally connected by a pivotal device consisting of a bolt or screw 4 and a nut 6. As illustrated in FIG. 10, the first scissor element 1 includes a through-hole 7 extending from a side of the first scissor element 1 through the other side of the first scissor element 1. Further, the second scissor element 2 includes a countersink 8 extending from a side of the second scissor element 2 through the other side of the second scissor element 2. The countersink 8 includes a smaller section 8b aligned with the through-hole 7 of the first scissor element 1 and a larger section 8a.

The screw 4 has a threaded shank 5 extending through the smaller section 8b of the countersink 8 and the through-hole 7 of the first scissor element 1 and then engaged with a screw hole 3 of the nut 6, with an enlarged head 4a of the screw 4 being fittingly received in the larger section 8a of the countersink 8.

Nevertheless, the pivotal arrangement is apt to be loosened, as the screw 4 directly contacts with and thus might move together with the first scissor element 1 and the second scissor element 2 that pivot relative to each other during use of the pair of scissors. Further, the exposed nut 6 may interfere with operation of the pair of scissors.

### SUMMARY OF THE INVENTION

In accordance with an aspect of the invention, a pair of scissors in accordance with the present invention includes a first scissor element, a second scissor element, and a pivotal device for pivotally engaging the first scissor element with the second scissor element. The first scissor element includes a countersink extending from a first side of the first scissor element through a second side of the first scissor element. The countersink of the first scissor element has a larger section facing away from the second scissor element and a non-circular smaller section facing the second scissor element.

The second scissor element includes a countersink extending from a first side of the second scissor element through a second side of the second scissor element. The countersink of the second scissor element has a larger section facing away from the first scissor element and a smaller section facing the first scissor element and aligned with the smaller section of the countersink of the first scissor element.

The pivotal device includes a screw and a nut. The screw includes a threaded shank and an enlarged head. The nut includes a non-circular shank and an enlarged head, with a screw hole extending through the non-circular shank and the enlarged head of the nut.

The nut is received in the countersink of the first scissor element, with the enlarged head of the nut being received in the larger section of the countersink of the first scissor element, and with the non-circular shank extending through the non-circular smaller section of the countersink of the first scissor element and the smaller section of the countersink of the second scissor element.

The threaded shank of the screw is threadedly engaged with the screw hole of the nut, with the enlarged head of the screw being received in the larger section of the countersink of the second scissor element.

Thus, the contact area between the screw and the pivotable scissor elements is small as compared to the conventional designs. Thus, the screw is less likely to move when the scissor elements pivot. The risk of loosening of the screw and/or the nut is reduced. A reliable pivotal arrangement is provided accordingly.

In an embodiment, the non-circular smaller section of the countersink of the first scissor element is substantially circular and comprises two parallel flat portions delimited by two parallel flat walls. Further, the non-circular shank of the nut is substantially circular and comprises two flat faces respectively in contact with the flat walls.

Alternatively, the non-circular smaller section of the countersink of the first scissor element may be square, rectangular, polygonal, or ellipsoid, and the non-circular shank of the nut may be square, rectangular, polygonal, or ellipsoid and in contact with a perimeter wall delimiting the non-circular smaller section of the countersink of the first scissor element.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an embodiment of a pair of scissors in accordance with the present invention.

FIG. 2 is an exploded perspective view of the pair of scissors in accordance with the present invention.

FIG. 2A is an enlarged view of a circled portion in FIG. 2.

FIG. 3 is an enlarged exploded perspective view of a pivotal device of the pair of scissors in accordance with the present invention.

FIG. 4 is a sectional view taken along plane 4-4 in FIG. 1.

FIG. 5 is a sectional view taken along plane 5-5 in FIG. 4.

FIG. 6 is an exploded perspective view of a modified embodiment of the pair of scissors in accordance with the present invention.

FIG. 6A is an enlarged view of a circled portion in FIG. 6.

FIG. 7 is an exploded perspective view of another modified embodiment of the pair of scissors in accordance with the present invention.

FIG. 7A is an enlarged view of a circled portion in FIG. 7.

FIG. 8 is an exploded perspective view of a further modified embodiment of the pair of scissors in accordance with the present invention.

FIG. 8A is an enlarged view of a circled portion in FIG. 8.

FIG. 9 is a perspective view of a pair of conventional scissors.

FIG. 10 is a sectional view illustrating pivotal arrangement of the pair of conventional scissors.

### DETAILED DESCRIPTION OF THE PREFERRED EMBODIMENTS

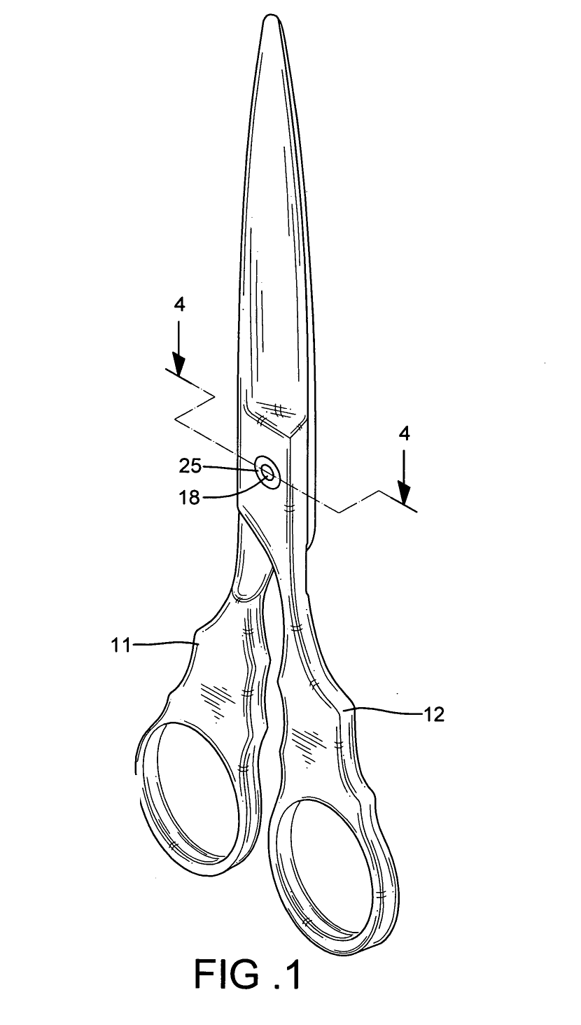

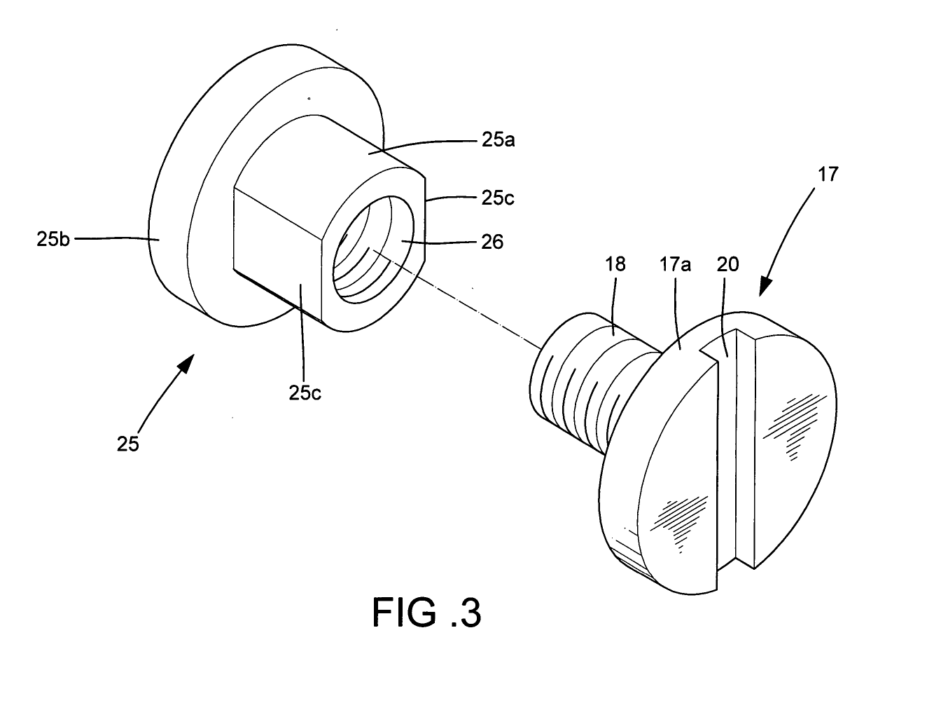

Referring to FIGS. 1 through 5, a pair of scissors in accordance with the present invention comprises a first scissor element 11, a second scissor element 12, and a pivotal device for pivotally engaging the first scissor element 11 with the second scissor element 12.

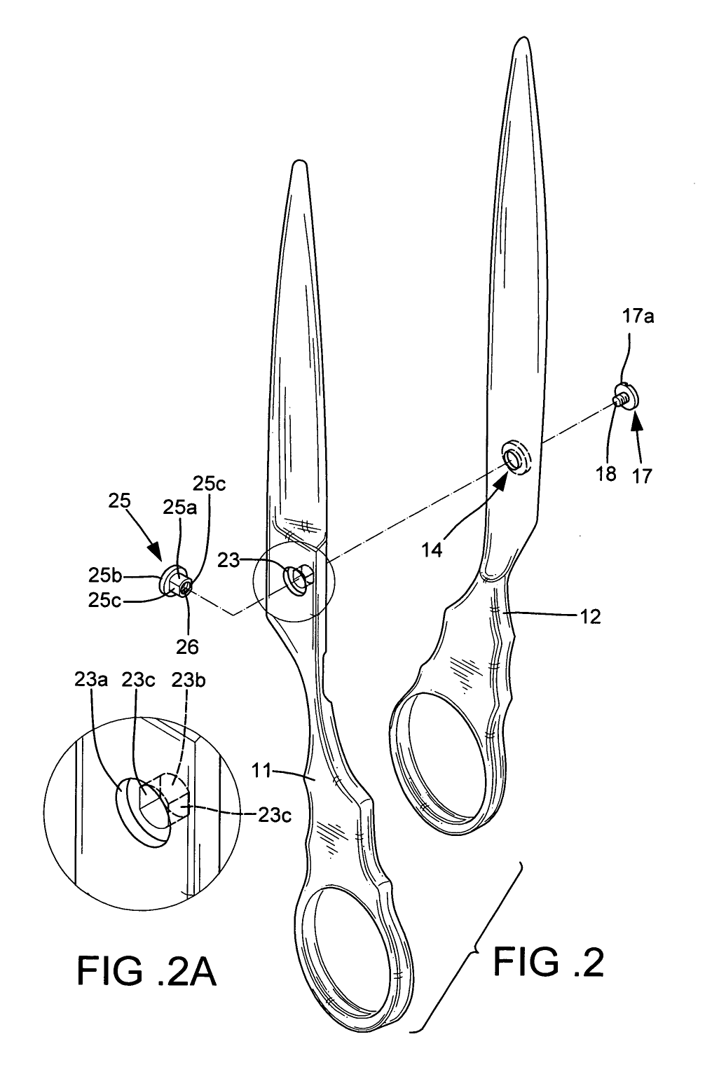

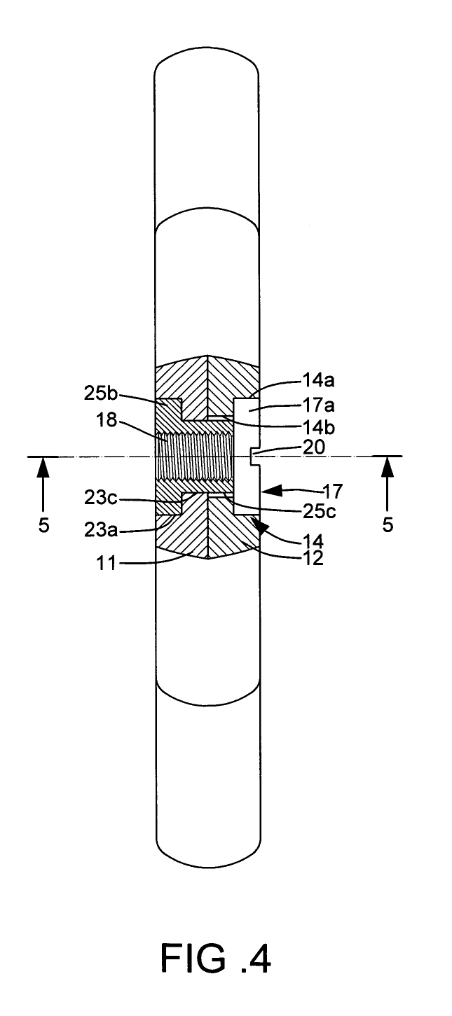

As illustrated in FIGS. 2, 2A, and 4, the first scissor element 11 includes a countersink 23 extending from a first side of the first scissor element 11 through a second side of the first scissor element 11. The countersink 23 of the first scissor element 11 has a larger section 23a facing away from the second scissor element 12 and a smaller section 23b facing the second scissor element 12. It is noted that the smaller section 23b is substantially circular and includes two flat portions 23c parallel to each other. In other words, the smaller section 23b is non-circular.

As illustrated in FIGS. 2 and 4, the second scissor element 12 includes a countersink 14 extending from a first side of the second scissor element 12 through a second side of the second scissor element 12. The countersink 14 of the second scissor element 12 has a larger section 14a facing away from the first scissor element 11 and a smaller section 14b facing the first scissor element 11 and aligned with the smaller section 23b of the countersink 23 of the first scissor element 11.

The pivotal device includes a bolt or screw 17 and a nut 25. The screw 17 includes a threaded shank 18 (having an outer threading) and an enlarged head 17a. The nut 25 includes a shank 25a and an enlarged head 25b, with a screw hole 26 extending through the shank 25a and the enlarged head 25b. Further, the shank 25a is substantially circular and includes two flat faces 25c parallel to each other. In other words, the smaller section 23b is non-circular.

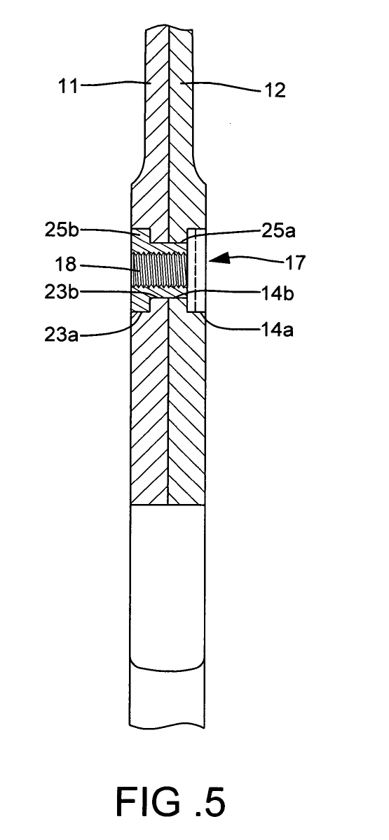

In assembly, as illustrated in FIGS. 4 and 5, the nut 25 is inserted into the countersink 23 of the first scissor element 11, with the enlarged head 25b being fittingly received in the larger section 23a of the countersink 23, and with the non-circular shank 25a extending through the non-circular smaller section 23b of the countersink 23 of the first scissor element 1 and the smaller section 14b of the countersink 14 of the second scissor element 12. It is noted that the flat faces 25c of the nut 25 are respectively in contact with two flat walls delimiting the flat portions 23c of the countersink 23. Next, the threaded shank 18 of the screw 17 is threadedly engaged with the screw hole 26 of the nut 25 until the enlarged head 17a of the screw 17 is fittingly received in the larger section 14a of the countersink 14 of the second scissor element 12. The enlarged head 17a of the screw 17 includes a slot 20, allowing the user to drive the screw 17 with a screwdriver or the like.

As can be seen from FIG. 4, the screw 17 is not in contact with the first scissor element 11, and the screw 17 is in contact with the second scissor element 12 at the enlarged head 17a. Thus, the contact area between the screw 17 and the pivotable scissor elements 11 and 12 is relatively small as compared to the conventional designs. Thus, the screw 17 is less likely to pivot when the scissor elements 11 and 12 pivot. The risk of loosening of the screw 17 and/or the nut 25 is reduced. A reliable pivotal arrangement is provided accordingly.

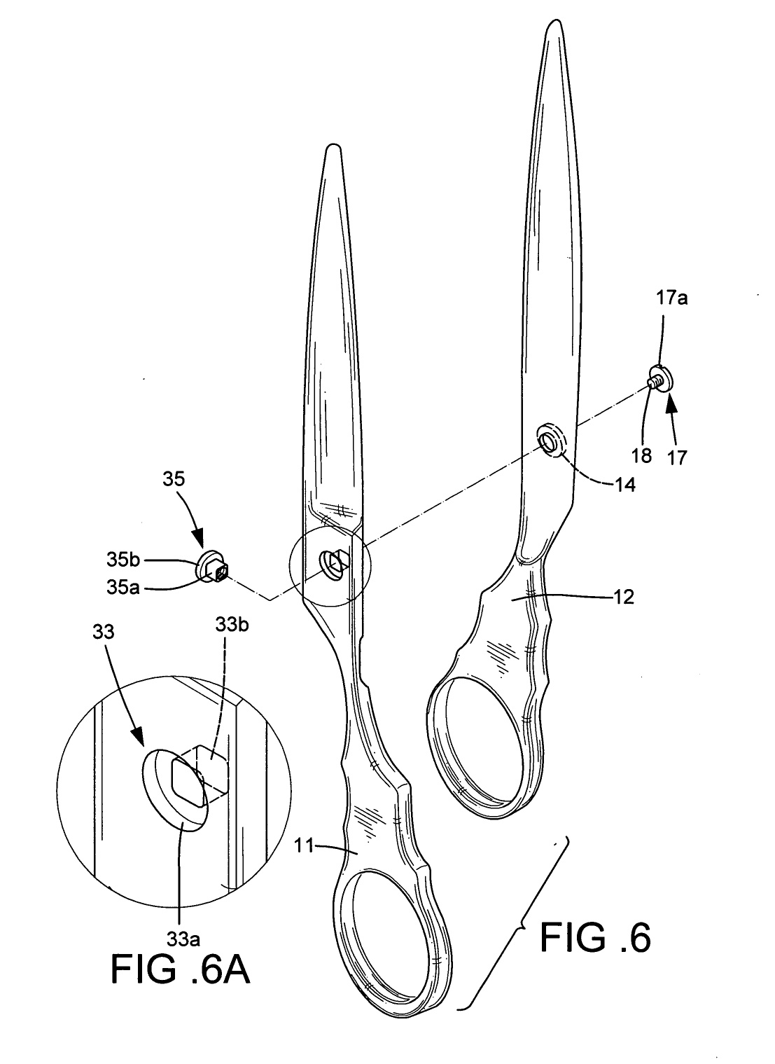

FIGS. 6 and 6A illustrate a modified embodiment of the invention, wherein the countersink (now designated by 33) of the first scissor element 11 has a larger section (now designated by 33a) facing away from the second scissor element 12 and a smaller section (now designated by 33b) facing the second scissor element 12. It is noted that the smaller section 33b is substantially square or rectangular. Further, the nut (now designated by 35) includes an enlarged head (now designated by 35b) and a substantially square or rectangular shank (now designated by 35a) having four sides (not labeled) that are respectively in contact with the four sidewalls delimiting the smaller section 33b of the countersink 33. This arrangement also provides a reliable pivotal device.

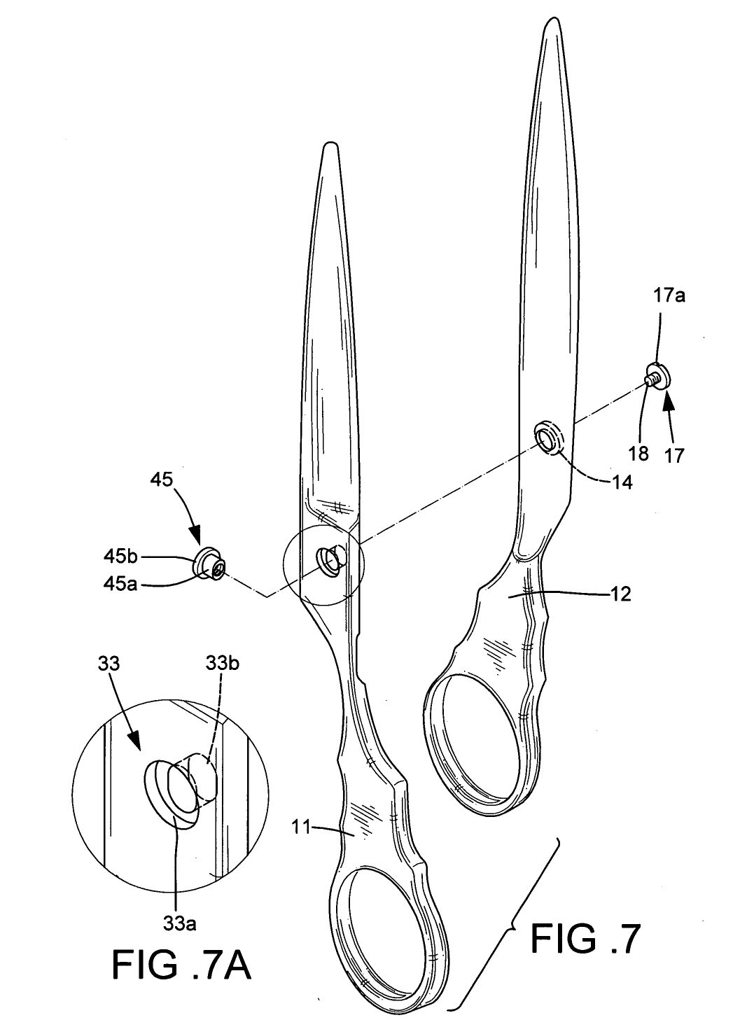

FIGS. 7 and 7A illustrate another modified embodiment of the invention, wherein the countersink (now designated by 43) of the first scissor element 11 has a larger section (now designated by 43a) facing away from the second scissor element 12 and a smaller section (now designated by 43b) facing the second scissor element 12. It is noted that the smaller section 43b is substantially ellipsoid. Further, the nut (now designated by 45) includes an enlarged head (now designated by 45b) and a substantially ellipsoid shank (now designated by 45a) in contact with a perimeter wall delimiting the smaller section 43b of the countersink 43. This arrangement also provides a reliable pivotal device.

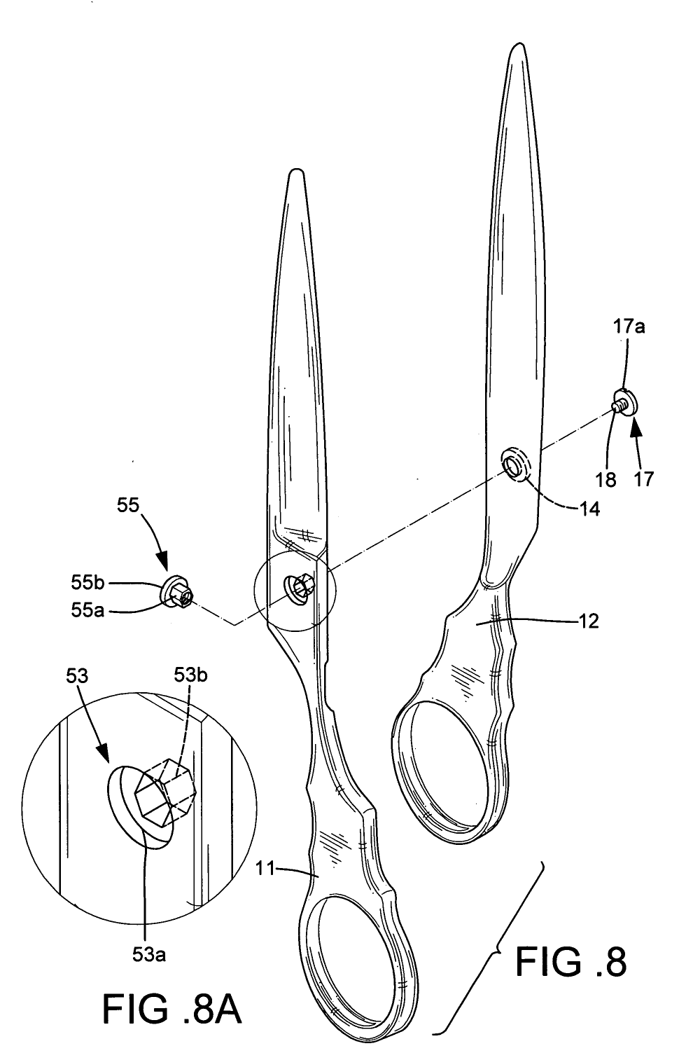

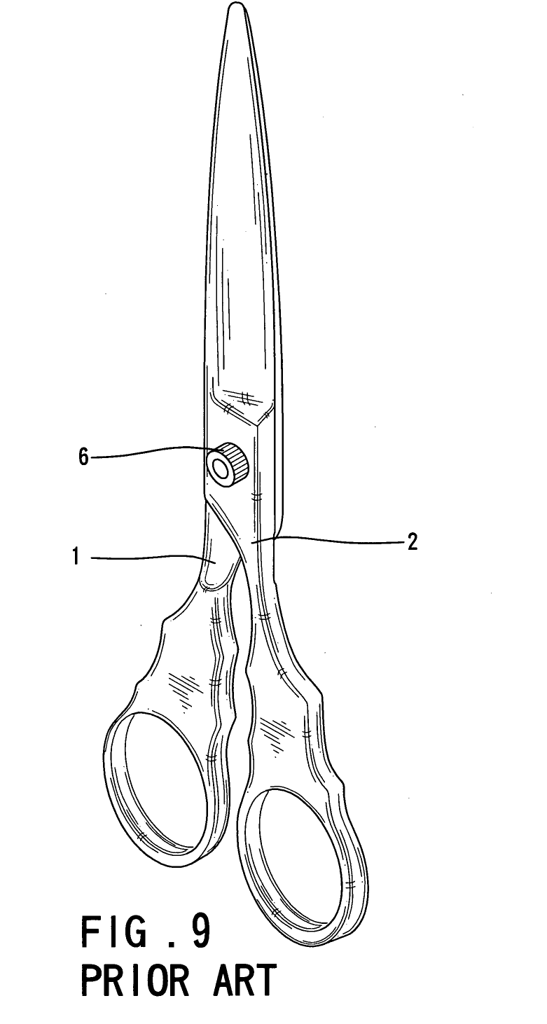

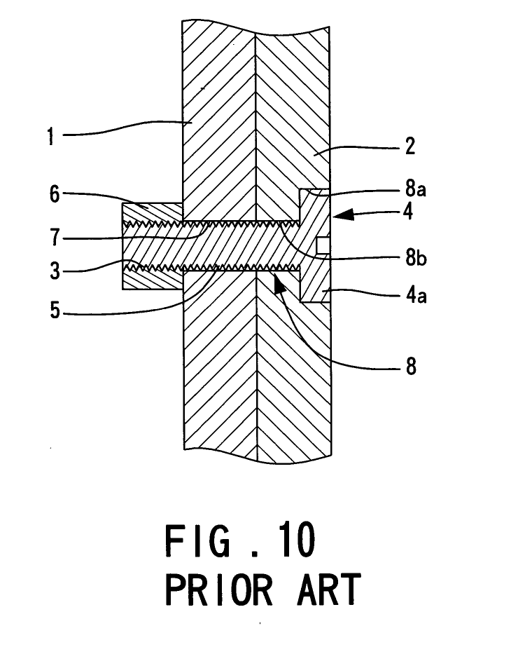

FIGS. 8 and 8A illustrate a further modified embodiment of the invention, wherein the countersink (now designated by 53) of the first scissor element 11 has a larger section (now designated by 53a) facing away from the second scissor element 12 and a smaller section (now designated by 53b) facing the second scissor element 12. It is noted that the smaller section 53b is polygonal (e.g., hexagonal). Further, the nut (now designated by 55) includes an enlarged head (now designated by 55b) and a polygonal (e.g., hexagonal) shank (now designated by 55a) having, e.g., sides (not labeled) that are respectively in contact with, e.g., sidewalls delimiting the smaller section 53b of the countersink 53. This arrangement also provides a reliable pivotal device.

It is noted that other non-circular arrangements for the smaller section 23b, 33b, 43b, 53b of the countersink 23, 33, 43, 53 and corresponding non-circular arrangements for the shank 25a, 35a, 45a, 55a of the nut 25, 35, 45, 55 can be used.

Although the invention has been explained in relation to the preferred embodiments, it is to be understood that many other possible modifications and variations can be made without departing from the scope of the invention as hereinafter claimed.

1. A pair of scissors comprising:
a first scissor element;
a second scissor element; and
a pivotal device for pivotally engaging the first scissor element with the second scissor element;
the first scissor element including a countersink extending from a first side of the first scissor element through a second side of the first scissor element, the countersink of the first scissor element having a larger section facing away from the second scissor element and a non-circular smaller section facing the second scissor element;
the second scissor element including a countersink extending from a first side of the second scissor element through a second side of the second scissor element, the countersink of the second scissor element having a larger section facing away from the first scissor element and a smaller section facing the first scissor element and aligned with the smaller section of the countersink of the first scissor element;
the pivotal device including a screw and a nut, the screw including a threaded shank and an enlarged head, the nut including a non-circular shank and an enlarged head, with a screw hole extending through the non-circular shank and the enlarged head of the nut;
the nut being received in the countersink of the first scissor element, with the enlarged head of the nut being received in the larger section of the countersink of the first scissor element, and with the non-circular shank extending through the non-circular smaller section of the countersink of the first scissor element and the smaller section of the countersink of the second scissor element; and
the threaded shank of the screw being threadedly engaged with the screw hole of the nut, with the enlarged head of the screw being received in the larger section of the countersink of the second scissor element.

2. The pair of scissors as claimed in claim 1, wherein the non-circular smaller section of the countersink of the first scissor element is substantially circular and comprises two parallel flat portions delimited by two parallel flat walls, and wherein the non-circular shank of the nut is substantially circular and comprises two flat faces respectively in contact with the flat walls.

3. The pair of scissors as claimed in claim 1, wherein the non-circular smaller section of the countersink of the first scissor element is one of square, rectangular, polygonal, and ellipsoid, and wherein the non-circular shank of the nut is one of square, rectangular, polygonal, and ellipsoid and in contact with a perimeter wall delimiting the non-circular smaller section of the countersink of the first scissor element.
